(19) United States
(12) Patent Application Publication
(10) Pub. No.: US 2025/0225722 A1
(43) Pub. Date: Jul. 10, 2025

(54) AGGREGATED BROADCAST OF VOLUMETRIC VIDEOS

(71) Applicant: International Business Machines Corporation, Armonk, NY (US)

(72) Inventors: Sarbajit K. Rakshit, Kolkata (IN); Satyam Jakkula, Bengaluru (IN); Binoy Thomas, Kozhikode (IN); Sudheesh S. Kairali, Kozhikode (IN)

(21) Appl. No.: 18/404,649

(22) Filed: Jan. 4, 2024

(51) Int. Cl. G06T 17/00; G06V 20/52; H04N 13/388

(52) U.S. Cl. CPC G06T 17/00; G06V 20/52; H04N 13/388

(57) ABSTRACT

A computer-implemented method (CIM), according to one approach, includes obtaining child video feed data from a plurality of user devices that are utilized to record a first event. A child volumetric video is generated using the obtained child video feed data. The CIM further includes causing the child volumetric video to be broadcast with a parent volumetric video of the first event on a display of a first VR device. A computer program product (CPP), according to another approach, includes a set of one or more computer-readable storage media, and program instructions, collectively stored in the set of one or more storage media, for causing a processor set to perform any combination of features of the foregoing methodology.

### BACKGROUND

The present invention relates to volumetric video, and more specifically, this invention relates to volumetric video displayed on a virtual reality (VR) device.

Volumetric video technology leverages cameras and advanced data processing to render three-dimensional (3D) images from a virtual space. More specifically, a volumetric video is produced by processing feeds from multiple cameras from various directions to create a volume of video. Furthermore, in order to create the volumetric video, computing processors may process multiple image feeds from different directions and create volumetric video. This allows for a current video point of view to be adjusted to any angle within that space to create a more immersive experience for viewers. For example, using volumetric video, a user can view media from various directions, e.g., using a VR system, a 3D display system or any two-dimensional (2D) display system.

### SUMMARY

A computer-implemented method (CIM), according to one approach, includes obtaining child video feed data from a plurality of user devices that are utilized to record a first event. A child volumetric video is generated using the obtained child video feed data. The CIM further includes causing the child volumetric video to be broadcast with a parent volumetric video of the first event on a display of a first VR device.

A computer program product (CPP), according to another approach, includes a set of one or more computer-readable storage media, and program instructions, collectively stored in the set of one or more storage media, for causing a processor set to perform any combination of features of the foregoing methodology.

A computer system (CS), according to another approach, includes a processor set, a set of one or more computer-readable storage media, and program instructions, collectively stored in the set of one or more storage media, for causing the processor set to perform any combination of features of the foregoing methodology.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach of the present invention.

FIG. 2 is a flowchart of a method, in accordance with one approach of the present invention.

FIG. 3A illustrates a VR device worn by a user, in accordance with one approach of the present invention.

FIG. 3B-3D illustrate a display of the VR device of FIG. 3A, in accordance with several approaches of the present invention.

FIG. 4 is a flowchart of a method, in accordance with one approach of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for causing a child volumetric video of a first event to be broadcast with a parent volumetric video of a first event on a display of a virtual reality (VR) device.

In one general approach, a CIM includes obtaining child video feed data from a plurality of user devices that are utilized to record a first event. A child volumetric video is generated using the obtained child video feed data. The CIM further includes causing the child volumetric video to be broadcast with a parent volumetric video of the first event on a display of a first VR device.

The user devices may utilize cloud storage, of a cloud server that is performing operations of the CIM, for streaming and/or storing the child video feed data. Accordingly, an additional processing load is not incurred by obtaining the child video feed data. Rather, the detailed user experience provided by broadcasting of the child volumetric video(s) with the parent volumetric video on the display of the first VR device may, in some approaches, only obtain and utilize child video feed data that is already being uploaded to the cloud server to relatively reduce an amount of processing resources that are expended in generating volumetric video feeds and/or collaboration environments. A technical benefit of this includes a relatively enhanced user experience being generated without incurring additional processing overhead in the process of doing SO.

In some approaches, a plurality of child volumetric videos are generated and caused to be broadcast with the parent volumetric video of the first event on the display. The method may further include obtaining parent video feed data from a plurality of dedicated volumetric video devices that are utilized to record the first event and generating, using the obtained parent video feed data, the parent volumetric video. The child volumetric videos are caused to be incorporated into at least one child collaboration environment, and the parent volumetric video is caused to be incorporated into a parent collaboration environment.

A technical effect of generating and causing a plurality of child volumetric videos to be displayed with the parent volumetric video includes a relatively enhanced user experience for a user who is viewing the display. This is, at least in part, enabled because the resulting volumetric videos being displayed are based on child video feed data that is obtained from the different user devices that had and/or have different viewing perspectives of the first event.

A technical effect of incorporating at least one of the child volumetric videos as a volumetric video feed into at least one child collaboration environment includes the creation of an interactive and immersive environment that users around the world can enjoy. This relatively enhances the technical fields of volumetric video and virtual words, because, as detailed elsewhere above, these technical fields are relatively limited in that they have always relied on use of dedicated cameras rather than incorporating user cameras that are already being utilized to record and/or uploaded child video feed data of a first event.

Relative locations of the user devices at the first event may be identified, and the identified relative locations may be incorporated into associated viewing perspectives within the child volumetric videos and the child collaboration environment(s).

A technical effect of this incorporation of the identified relative locations into associated viewing perspectives within the child volumetric videos and the child collaboration environment(s) includes the child volumetric videos and the child collaboration environment(s) being ensured to also have a plurality of different viewing perspectives. This increases a relative depth of a user experience of a user who views the display.

The method, in some approaches, further includes evaluating the child video feed data to determine recording behavior similarities of operators of a first subset of the user devices during the recording of the first event. Causing the child volumetric videos to be broadcast with the parent volumetric video of the first event on the display may include assigning the parent volumetric video to a majority portion of the display, assigning the child volumetric videos generated using the child video feed data obtained from the first subset of the user devices to first minority portions of the display, and assigning a remainder of the child volumetric videos to second minority portions of the display. Each of the first minority portions of the display are grouped together on the display. The first minority portions of the display are not grouped together with the second minority portions on the display.

A technical effect of evaluating the child video feed data to determine recording behavior similarities and basing assignments of volumetric videos on the display based on the evaluation includes establishing contextual groupings of volumetric videos on the display. By determining these groupings before the volumetric videos are caused to be output on the display, an amount of processing that would otherwise be performed in order to rearrange the volumetric videos into such groupings is relatively reduced.

The first minority portions of the display may include first contours to be distinguishable from the majority portion of the display, and the second minority portions of the display may include second contours to be distinguishable from the majority portion of the display. The recording behavior similarities may, depending on the approach, include an amount of time spent recording a person of interest exceeding a predetermined threshold within a predetermined amount of time, an amount of time spent recording an object of interest exceeding a predetermined threshold within a predetermined amount of time, and a first sports team being recorded relatively more than a second sports team.

A technical effect of incorporating contours into portions of the display includes the addition of a visual ordering within the display. This ordering optionally prevents different volumetric videos from being visually blended together, which is useful for approaches in which at least some of the volumetric videos are based on different and non-contiguous viewing perspectives of the first event.

The CIM may further includes assigning one of the child volumetric videos to the majority portion of the display and assigning the parent volumetric video to one of the minority portions of the display in response to a determination that a predetermined selection action has been performed.

A technical effect of performing this reassignment in response to a determination that a predetermined selection action has been performed includes a dynamic viewing experience that is adaptive to a viewing user's viewing preferences. Rather than generating an entirely new volumetric video, which would otherwise consume additional processing resources and incur processing bandwidth, this optional reassignment utilizes volumetric videos that have already been generated and are currently displayed on the display of the VR device.

The method may further include causing the child volumetric video to be incorporated into a child collaboration environment, and causing the parent volumetric video to be incorporated into a parent collaboration environment that is a different collaboration environment than the child collaboration environment. A contextual analysis of the child volumetric video and the parent volumetric video may be performed to determine correlations between the child collaboration environment and the parent collaboration environment, and a parent-child collaboration environment that incorporates first aspects of the child collaboration environment and second aspects of the parent collaboration environment may be generated based on the determined correlations.

A technical effect of generating the parent-child collaboration environment includes relative enhancement of the collaboration environment in that blended collaboration environments are enabled (blended based on the incorporation of the first aspects of the child collaboration environment and second aspects of the parent collaboration environment). This relatively expands the technical field of volumetric videos and virtual worlds which has never previously offered this technical effect.

The method may further include generating hierarchical navigation paths that enable navigation between the different collaboration environments. User selections may be received, and in response to a determination that the user selections pursue a predetermined first one of the hierarchical navigation paths, predetermined first assignments that are associated with the predetermined first hierarchical navigation path may be caused to be output to the VR device.

The generated hierarchical navigation paths allow users viewing the display to visualize collaboration environments while in a different collaboration environment, and therefore have a technical effect of promoting navigation within the different collaboration environments.

The method may further include obtaining user input that details predetermined parameters to incorporate into a parent-child collaboration environment. The predetermined parameters may include sports team preferences, club memberships, and collaboration interaction preferences, in some approaches. The parent-child collaboration environment may be generated based on the obtained user input and thereby incorporate the predetermined parameters.

A technical effect of incorporating these user inputs includes tailoring user preferences into the collaboration environments. A computing performance benefit that is enabled by tailoring user preferences into collaboration environments includes relatively reducing an amount of processing operations that would otherwise be performed processing user-initiated adjustments (where the adjustment would otherwise be initiated if the collaboration environments did not consider such preferences before being output for display).

In another general approach, a CPP includes a set of one or more computer-readable storage media, and program instructions, collectively stored in the set of one or more storage media, for causing a processor set to perform any combination of features of the foregoing methodology. Similar technical effects are obtained.

In another general approach, a CS includes a processor set, a set of one or more computer-readable storage media, and program instructions, collectively stored in the set of one or more storage media, for causing the processor set to perform any combination of features of the foregoing methodology. Similar technical effects are obtained.

In some preferred approaches, a CIM includes obtaining child video feed data from a plurality of user devices that are utilized to record a first event. A plurality of child volumetric videos are generated using the obtained child video feed data. The method may further include obtaining parent video feed data from a plurality of dedicated volumetric video devices that are utilized to record the first event, and generating, using the obtained parent video feed data, a parent volumetric video. The CIM further includes causing the child volumetric videos to be broadcast with the parent volumetric video of the first event on a display of a first VR device. The parent volumetric video may be assigned to a majority portion of the display, and the child volumetric videos are assigned to minority portions of the display.

The CIM described above does not incur an additional processing load when obtaining the child video feed data. Rather, the detailed user experience provided by broadcasting of the child volumetric video(s) with the parent volumetric video on the display of the first VR device may, in some approaches, only obtain and utilize child video feed data that is already being uploaded to the cloud server to relatively reduce an amount of processing resources that are expended in generating volumetric video feeds and/or collaboration environments. A technical benefit of this includes a relatively enhanced user experience being generated without incurring additional processing overhead in the process of doing so. Furthermore, a technical effect of assigning the different volumetric videos to different portions of the display includes different viewing perspectives of the first event.

A relevant use case of the CIM described above involves events in which a plurality of users are present viewing the first event. Illustritive examples of these events include sporting events, concerts held in a stadium, etc., in which user devices are already being used to record and/or stream the first event. Because many of these user devices may be uploading such data to a cloud server, this information is readily available to use for generating the different volumetric videos that are then used to create a navigable user experience.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as volumetric video aggregation code of block 150 for causing a child volumetric video of a first event to be broadcast with a parent volumetric video of a first event on a display of a virtual reality (VR) device. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

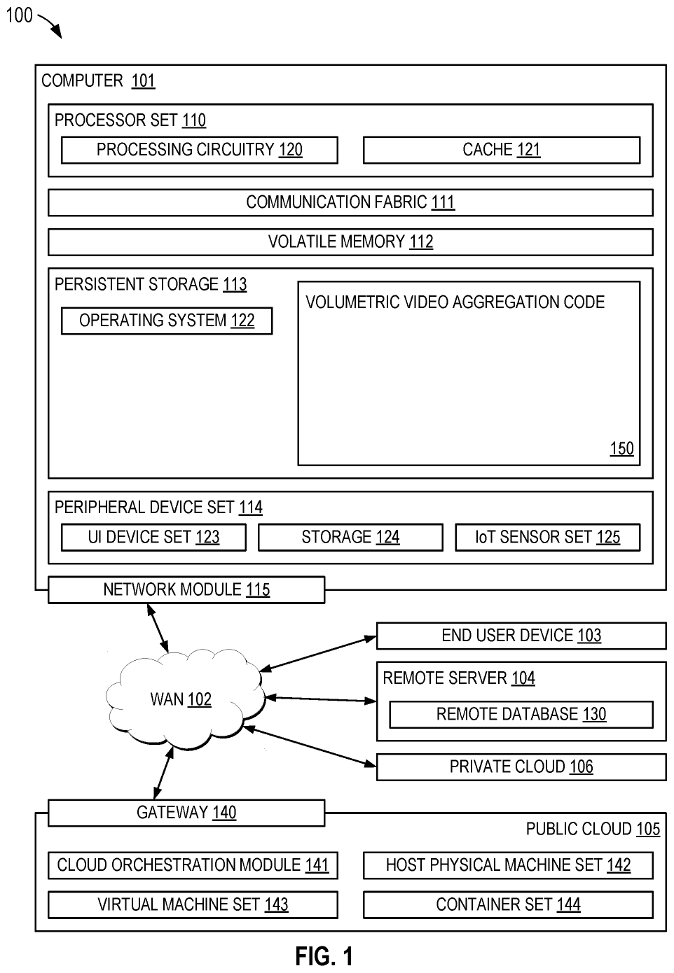

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As mentioned elsewhere herein, volumetric video technology leverages cameras and advanced data processing to render 3D images from a virtual space. More specifically, a volumetric video is produced by processing feeds from multiple cameras from various directions to create a volume of video. Furthermore, in order to create the volumetric video, computing processors may process multiple image feeds from different directions and create volumetric video. This allows for a current video point of view to be adjusted to any angle within that space to create a more immersive experience for viewers. For example, using volumetric video, a user can view media from various directions, e.g., using a VR system, a 3D display system or any 2D display system.

Conventional volumetric videos are typically generated using feeds of dedicated cameras. For example, dedicated cameras are typically positioned at predetermined locations within a venue where a live event is scheduled to occur so that feeds of the dedicated cameras can be used to generate a volumetric video during and/or after the live event. Audience members who are present at such live events often use user devices to capture video of the live events from different directions. However, conventional volumetric videos fail to incorporate video clips and/or feeds captured using user devices, and instead primarily rely on video feeds from dedicated cameras.

In order to relatively enhance the viewing experience of volumetric videos, the techniques of approaches and approaches described herein include creating a second volumetric video using user devices that are presently recording at and/or were present and recorded at a live event, that is incorporated into, e.g., broadcast along with, a first volumetric video that may have been generated using feeds of cameras selectively positioned at an event for the purpose of generating a volumetric video of the event. In some approaches, these second volumetric videos may additionally and/or alternatively be used to create a virtual world collaboration along with the live event, e.g., such as a fan club which is described in greater detail elsewhere below, and might additionally and/or alternatively be broadcast along with the first volumetric video.

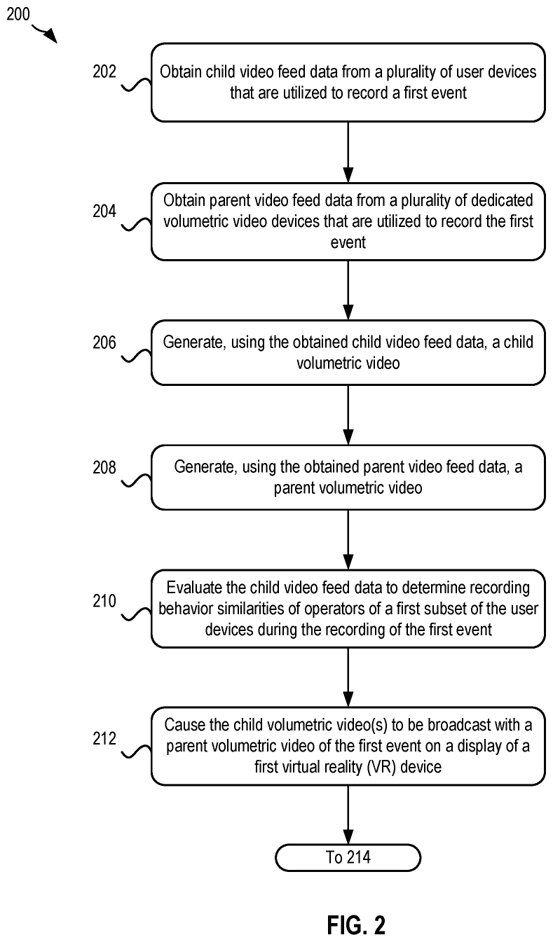

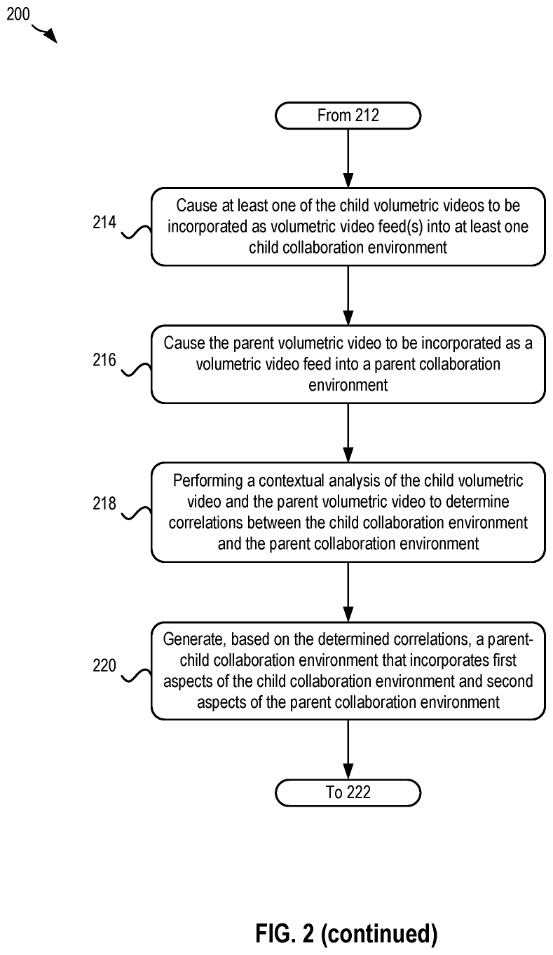

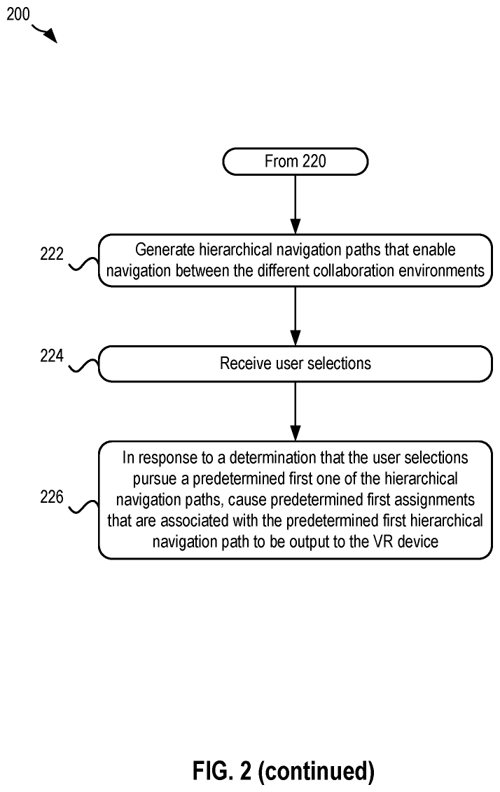

Now referring to FIG. 2, a flowchart of a method 200 is shown according to one approach. The method 200 may be performed in accordance with the present invention in any of the environments depicted in FIGS. 1-4, among others, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that, in some approaches, method 200 may be performed by a processing circuit that is configured to receive data from one or more devices that may be members of a network. For example, in some preferred approaches, method 200 is performed by a cloud server that is in communication with, and thereby configured to receive data from, a plurality of user devices that each have a camera component and/or are paired with a camera component. In some other approaches, method 200 may be performed by a VR device that includes a display, where the VR device is in communication with, and thereby configured to receive data from, a plurality of user devices that each have a camera component and/or are paired with a camera component.

Operation 202 includes obtaining child video feed data from a plurality of user devices that are utilized to record a first event. For context, the user devices may be “utilized to record” the first event based on the user devices actively recording the first event. These user devices may additionally and/or alternatively be “utilized to record” the first event based on the user devices having previously recorded the first event. For context, the child video feed data may, in some approaches, include a video recording of the first event and/or metadata associated therewith. The child video feed data may be received as the recording is being performed, e.g., in real time, or, in some other approaches, have been previously recorded and thereafter uploaded to a predetermined database, e.g., storage of a cloud server. While in some approaches, the child video feed data may be received over a period of time, e.g., such as where the child video feed data is obtained in about real time of recording of the first event, in a plurality of packets, etc., in some other approaches, the child video feed data may be received all at once, e.g., such as where all of the child video feed data is uploaded to a cloud server after the recording is performed. Because the child video feed data is obtained from user devices, in some approaches, obtaining the child video feed data from a plurality of user devices may include querying user devices for the data, while in some other approaches, the child video feed data may be received as a result of owners of the user devices opting into a data sharing service associated with the first event. For example, users may share a live stream feed of the live event from their user device to a broadcasting provider, such as a social network site, and the child video feed data may be obtained from the social network site. It should be noted that the child video feed data is only obtained from the plurality of user devices subsequent to gaining permission from the users, and this permission may be withdrawn by the users at any time.

The first event may be any type of event, and in some approaches, preferably includes an event that user devices are able to be present at and record at. For example, an illustritive list of such events includes, e.g., sporting events, a speech, a debate, a scenic view, etc. As mentioned elsewhere above, the user devices preferably each have a camera component and/or are paired with a camera component. For example, the user devices may include, e.g., a cellular phone, a tablet computer, a camera, etc. Accordingly, the child video feed data may be a recording of one or more portions of the event. For example, in some use cases, the child video feed data includes different recordings of a sporting event that were recorded using a plurality of different user devices by users that were audience members at the sporting event. In some preferred approaches, the child video feed data includes recordings taken from different relative locations at the first event. For context, these different relative locations may allow the child video feed data to be used to generate a volumetric video, as will be described in greater detail elsewhere herein.

Other data may be obtained in method 200. For example, parent video feed data is, in some approaches, obtained from a plurality of dedicated volumetric video devices that are utilized to record the first event, e.g., see operation 204. The parent video feed data is different from the child video feed data. Furthermore, the dedicated volumetric video devices are preferably different devices than the user devices from which the child video feed data is obtained. For context, in some approaches, the dedicated volumetric video devices are “dedicated” based on the dedicated volumetric video devices being installed, e.g., fixedly mounted, at a location that the first event occurs, e.g., a stadium, a classroom, a concert venue, etc. In other words, in one or more of such approaches, the dedicated volumetric video devices are dedicated to recording events, such as the first event, in order to generate parent video feed data.

Similar to the child video feed data, the parent video feed data may, in some approaches, include a video recording of the first event and/or metadata associated therewith. The parent video feed data may be received as the recording is being performed, e.g., in real time, or, in some other approaches, have been previously recorded and thereafter uploaded to a predetermined database, e.g., storage of the cloud server. While in some approaches, the parent video feed data may be received over a period of time, e.g., such as where the parent video feed data is obtained in about real time of the recording of the first event, in a plurality of packets, etc., in some other approaches, the parent video feed data may be received all at once, e.g., such as where all of the parent video feed data is uploaded to the cloud server after the recording is performed.

The dedicated volumetric video devices preferably each have a camera component and/or are paired with a camera component. For example, the dedicated volumetric video devices may include, e.g., security cameras, remote cameras, etc. Accordingly, the parent video feed data may be a recording of at least a majority of the event. For example, in some use cases, the parent video feed data includes a recording of a sporting event that is recorded using a plurality of different dedicated volumetric video devices that are installed and/or manually operated to record the sporting event. In some preferred approaches, the parent video feed data includes recordings taken from different relative locations at the first event. For context, these different relative locations may allow the parent video feed data to be used to generate a volumetric video, as will be described in greater detail elsewhere herein.

Operation 206 includes generating at least one child volumetric video. In some preferred approaches, a plurality of child volumetric videos are generated. The child volumetric videos are preferably generated using the obtained child video feed data. A technical effect of generating and causing a plurality of child volumetric videos to be displayed with the parent volumetric video includes a relatively enhanced user experience for a user that is viewing the display. This is, at least in part, enabled because the resulting volumetric videos being displayed are based on child video feed data that is obtained from the different user devices that had and/or have different viewing perspectives of the first event.

Techniques that would become apparent to one of ordinary skill in the art after reading the descriptions herein may be performed in order to generate one or more child volumetric videos using obtained child video feed data. For example, in some approaches, different video recording of the event within the obtained child video feed data may be overlayed on one another to create a first of the child volumetric videos, e.g., patched together. At least some of the child volumetric videos include an amount of data that allows a selectively adjustable 3D viewing perspective of the child volumetric video to be changed during the child volumetric video being displayed on a predetermined device, e.g., such as a virtual reality device display.

Operation 208 includes generating the parent volumetric video. The parent volumetric video may be generated using similar techniques described above with respect to the child volumetric videos, however, it should be noted that the parent volumetric video is preferably generated using the obtained parent video feed data and not the obtained child video feed data, while the child volumetric videos are preferably generated using the obtained child video feed data and not the obtained parent video feed data. In some approaches, generating the parent volumetric video includes outputting instructions with positional adjustments to at least some of the dedicated volumetric video devices during active recording of the first event in order to cause the dedicated volumetric video devices to capture data that may be missing from obtained parent video feed data based on a current positioning of the dedicated volumetric video devices.

In some preferred approaches, the dedicated volumetric video devices may be a relatively more established set of cameras than the cameras of the user devices. In other words, in some approaches, the dedicated volumetric video devices are hardwired cameras at the first event and the user devices are cellular phones. The dedicated volumetric video devices may be relatively more established in that they include cameras with relatively more processing resources and/or hardware such as lenses. Accordingly, in some approaches, the child volumetric videos include a relatively more focused view of the first event, while the parent volumetric video may include a relatively broader view of the first event. In one contextual example, the first event may be a sporting event held in a sports stadium full of audience members (fans of teams playing at the first event). In such an example, the child volumetric videos may be based on child video feed data that includes a recording taken from a first audience member's seat and primarily focuses on one or more players of the teams. In contrast, within this example, the parent volumetric video may be based on parent video feed data that includes a recording taken from around the sports stadium by the plurality of dedicated volumetric video devices, and the parent volumetric videos may primarily focus on the entire sports stadium (and any sub-portion thereof) rather than just limited sub-portions of the sports stadium (of child volumetric videos that only focus on one or more of the players visible from the a first audience member's seat).

Operation 212 includes causing the child volumetric video(s) to be broadcast with a parent volumetric video of the first event on a display of a first virtual reality (VR) device, e.g., broadcast of the volumetric videos are aggregated to be displayed on the same display. The VR device may be a type of device that would become apparent to one of ordinary skill in the art after reading the descriptions herein. In some preferred approaches, the VR device may be a VR headset that has controls for navigating the volumetric videos. For example, in some approaches, a handheld controller that is paired with the VR headset may include buttons that are configured to receive user input for enabling corresponding predetermined navigation movements about the volumetric videos. In some other approaches, the VR headset may be configured to monitor (such as with a camera, microphone, an accelerometer, etc.) for predetermined user gestures, e.g., hand swipes, head movements, walking, etc. Each of these predetermined user gestures may be pre-associated with a different type of navigation within the one or more of the volumetric videos.

The VR device display, in some preferred approaches, includes a plurality of different portions that the volumetric videos can be displayed on. In order to determine how to organize the different volumetric videos on the display, in some approaches, one or more predetermined evaluation operations are performed. For example, operation 210 includes evaluating the child video feed data to determine recording behavior similarities of operators of a first subset of the user devices during the recording of the first event. For context, recording behavior similarities of operators of at least some of the user devices may, in some approaches, be determined in order to determine similar volumetric videos. These recording behavior similarities may be based on one or more predetermined behavioral factors.

In some approaches, one of these behavioral factors that the recording behavior evaluation may be based on includes an amount of time spent recording a person of interest exceeding a predetermined threshold within a predetermined amount of time. In such approaches, the person of interest may be a particular player of a sports team. Accordingly, recording behavior that focuses on such a player for more time than the predetermined threshold of time within the predetermined amount of time may establish samples of the child video feed data that were generated by users who are fans of the same player. In such an approach, the recording behavior similarities of the operators (users that own the user devices) may be identified and used for forming a first subset of the user devices, e.g., thereby establishing a viewing perspective as if the viewer of the display is in a fan club watching the first event. For context, forming the first subset of the user devices establishes a “club” that may be incorporated into an organized subset of the volumetric videos on the display (as will be described in further detail elsewhere herein). Another behavioral factor that the recording behavior evaluation may be based on includes an amount of time spent recording an object of interest exceeding a predetermined threshold within a predetermined amount of time. In yet another approach, a behavioral factor that the recording behavior evaluation may be based on includes a first sports team being recorded relatively more than a second sports team while recording the first event. In contrast, user devices that are determined to have not been used and/or that are not being actively used during the first event in such a way that fulfills the behavioral factors recording behavior similarities, are not included in the first subset of the user devices and may be assigned to a unique group or to another group of the user devices having the same recording behavior similarities.

A technical effect of evaluating the child video feed data to determine recording behavior similarities and basing assignments of volumetric videos on the display based on the evaluation includes establishing contextual groupings of volumetric videos on the display. By determining these groupings before the volumetric videos are caused to be output on the display, an amount of processing that would otherwise be performed in order to rearrange the volumetric videos into such groupings is relatively reduced.

It should be noted that the user devices may utilize cloud storage, of a cloud server that is performing method 200, for streaming and/or storing the child video feed data. Accordingly, in some approaches, an additional processing load is not incurred by obtaining the child video feed data. Rather, the detailed user experience provided by broadcasting of the child volumetric video(s) with the parent volumetric video on the display of the first VR device may, in some approaches, only obtain and utilize child video feed data that is already being uploaded to the cloud server to relatively reduce an amount of processing resources that are expended in generating volumetric video feeds and/or collaboration environments.

With reference again to operation 210, in some approaches, causing the child volumetric videos to be broadcast with the parent volumetric video of the first event on the display includes assigning, e.g., in instructions output to the VR device, the parent volumetric video to a majority portion of the display. The majority portion of the display is preferably greater than any other portions of the display that include other volumetric videos, and in some approaches, may be greater than a combined size of all the other portions of the display. Furthermore, in some approaches, the majority portion of the display may be centered with respect to a center of the display. The child volumetric videos generated using the child video feed data obtained from the first subset of the user devices are, in some approaches, assigned, e.g., in instructions output to the VR device, to first minority portions of the display. One or more of the minority portions of the display described herein may be a fraction of the size of the majority portion of the display, e.g., one fifth, one-tenth, one-twentieth, etc. In some approaches, a remainder of the child volumetric videos are assigned, e.g., in instructions output to the VR device, to second minority portions of the display. One or more of the remainder of the child volumetric videos may optionally be withheld, e.g., via an instruction, from being displayed on the display in order to preserve processing potential that would otherwise be expended displaying all of the child volumetric videos on the display. It may be noted that each of the first minority portions of the display are preferably grouped together on the display. In contrast, the first minority portions of the display are preferably not grouped together with the second minority portions on the display.

In one or more of these approaches, these different portions of the display are distinguishable from one another and allow a user viewing the VR device display to relatively easily visually recognize that different volumetric videos are displayed on the display. In order to cause these different portions of the display to be distinguishable from one another, in some approaches, contours may be added for some of the portions of the display. For example, the first minority portions of the display may be caused, e.g., via an instruction output to the VR device, to include first contours to be distinguishable from the majority portion of the display. Furthermore, the second minority portions of the display may be caused to include second contours to be distinguishable from the majority portion of the display. These contours may include dashed lines, solid lines, etc., and may be shaped along an edge of the different volumetric videos, e.g., thereby shaped as boxes, circles, triangles, ovals, etc.

A technical effect of incorporating contours into portions of the display includes the addition of a visual ordering within the display. This ordering optionally prevents different volumetric videos from being visually blended together, which is useful for approaches in which at least some of the volumetric videos are based on different and non-contiguous viewing perspectives of the first event.

Assignments of the different volumetric videos to the portions of the display are, in some approaches, not fixed, and may be adjusted. For example, in some approaches, the assignments may be adjusted, e.g., reassignment instructions may be output to the VR device. In one or more of such approaches, in response to a determination that a predetermined selection action has been performed, reassignments may be performed to one or more of the child volumetric videos and/or to the parent volumetric video. For example, in response to a determination that a predetermined selection action has been performed, method 200 may include assigning one of the child volumetric videos determined to be associated with the predetermined selection action to the majority portion of the display and assigning the parent volumetric video to one of the minority portions of the display. A technical effect of performing this reassignment in response to a determination that a predetermined selection action has been performed includes a dynamic viewing experience that is adaptive to a viewing user's viewing preferences. Rather than generating an entirely new volumetric video, which would otherwise consume additional processing resources and incur processing bandwidth, this optional reassignment utilizes volumetric videos that have already been generated and are currently displayed on the display of the VR device.

In one illustritive approach, the parent volumetric video may be swapped into a contour of the child volumetric video and the child volumetric video is swapped into the majority portion of the display of the VR device. In another approach, in response to a determination that a predetermined selection action has been performed, method 200 may include causing reassignments of the child volumetric videos within the display, e.g., swapping a first child volumetric video of the first minority portions of the display with a first child volumetric video of the second minority portions of the display, swapping a first child volumetric video of the first minority portions of the display with a child volumetric video that was generated but not assigned to a minority portion of the display in order to preserve processing resources, adding an additional child volumetric video to the first minority portions of the display, removing a child volumetric video from the first minority portions of the display, etc.

In the approaches above, the predetermined selection action may include an action performed on the first VR device and/or another device associated with the first VR device, e.g., such as a remote that is paired with the VR device. The action may include a selection action being made to a button of the remote and/or VR device. Furthermore, one or more of the volumetric videos may be determined to be associated with the predetermined selection action based on eye focus monitoring performed on a user wearing the VR device. For example, in some approaches, a first of the volumetric videos may be determined to be associated with the predetermined selection action based on an eye of the user being focused on the first volumetric video at the time the selection action is performed. In another approach, a selection action may be made with respect to more than one of the volumetric videos. For example, swapping of the placement of two volumetric videos on the display may, in some approaches, be performed in response to a determination that a user's eye(s) were focused on a first of the volumetric videos on the display at a time that a selection is made on a remote and thereafter the focus of the user's eye(s) transitioned to the second of the volumetric videos on the display.

Although various approaches described above describe how controls of the VR device and/or a remote paired with the VR device may be used to identify a predetermined selection action, in some approaches, a predetermined user gesture such as swiping and/or pointing may additionally and/or alternatively be identified and used as the basis for performing a reassignment of volumetric videos on the display. For example, in some approaches, monitoring may be performed for predetermined hand gestures that, along with tracked eye movements, may be used for determining whether to and/or how to perform reassignments of the volumetric videos on portions of the display. For example, information associated with such monitoring may be received and used in updated assignment instructions that are output to the VR device. Any monitoring performed on users and/or user devices described herein is preferably only performed in response to receiving authorization of the users that are being monitored. Furthermore, users are free to, at any time, withdraw this authorization, and in response to receiving such a withdrawal, such monitoring and use of user data ceases.

The child volumetric videos and the parent volumetric video described above may, in some approaches, be broadcast together in collaborative environments so that participating users viewing the volumetric videos on the VR device can navigate both the parent and child volumetric videos. For context, in some preferred approaches, these collaboration environments may be virtual world(s) in a virtual location that are computer-simulated and able to be navigated by one or more viewing users. In some approaches, one or more of these users are themselves represented within the collaboration environments by a personal avatar. In order to add detail to these collaborative environments, in some approaches, method 200 includes causing at least one of the child volumetric videos to be incorporated as a volumetric video feed into at least one child collaboration environment, e.g., see operation 214.

A technical effect of incorporating at least one of the child volumetric videos as a volumetric video feed into at least one child collaboration environment includes the creation of an interactive and immersive environment that users around the world can enjoy. This relatively enhances the technical fields of volumetric video and virtual words, because, as detailed elsewhere above, these technical fields are relatively limited in that they have always relied on use of dedicated cameras rather than incorporating user cameras that are utilized to record and/or upload child video feed data of a first event.

In some approaches in which multiple child volumetric videos are generated, each of the child volumetric videos may be incorporated as a volumetric video feed into a different child collaboration environment and/or more than one of the child volumetric videos may be incorporated into the same child collaboration environment. In order to incorporate child volumetric video(s) into child collaboration environment(s), method 200 may include, e.g., outputting a video stream of the child volumetric video(s) to a server that hosts the child collaboration environment(s), blending the child volumetric video(s) into a preexisting virtual world to establish the child collaboration environment(s), adding the child volumetric video(s) into displays within the preexisting virtual worlds, etc. While watching the volumetric video in a child collaboration environment, viewing users may request that additional child collaboration environment(s) be created. The request may include specific aspects to base the additional child collaboration environment(s) on, e.g., fan club preferences, and multiple users may be invited to join inside the additional child collaboration environment(s).

It should be noted that in some approaches, in order to generate a given one of the child volumetric videos, the child video feed data of a plurality of the user devices may need to be combined. This is because using the child video feed data of a single stationary user device may restrict navigation within the given child volumetric video to a position that the single stationary user device is located at within an environment that the first event occurs at, e.g., a seat within a sports stadium. Accordingly, in some approaches method 200 includes identifying relative locations of the user devices at the first event with respect to one another, and incorporating, e.g., aligning, the identified relative locations into associated viewing perspectives within the child volumetric videos and the child collaboration environment(s). In other words, in response to a determination that a relative position of a camera of a first user device at the first event is orientated at a first end of the first event (such as a sports stadium), an associated first viewing perspective portrayed within the child volumetric video within one of the child collaboration environment is caused to be at a first end of a simulated event. This viewing perspective may be dynamically changed to a different viewing perspective, e.g., that is based on an identified relative location of a second one of the user devices, in response to receiving an indication that a user using the VR device initiates navigation down a different generated hierarchical navigation path associated with the collaboration environment, as will be described in greater detail below. A technical effect of this incorporation of the identified relative locations into associated viewing perspectives within the child volumetric videos and the child collaboration environment(s) includes the child volumetric videos and the child collaboration environment(s) being ensured to also have a plurality of different viewing perspectives. This increases a relative depth of a user experience of a user that views the display.

Operation 216 includes causing the parent volumetric video to be incorporated as a volumetric video feed into a parent collaboration environment such as a virtual world that is a different collaboration environment than the child collaboration environment. The parent volumetric video is, in some approaches, at least initially displayed in the majority portion of the display. However, because the respective assignments of the volumetric videos on the display may be changed, e.g., based on reassignments, in some approaches, at some point, one of the child volumetric videos may be assigned to the majority portion of the display in order to enable exploration of the one or more of the child collaboration environments.

Various approaches described herein detail separate parent collaboration environments and child collaboration environments that may be displayed together on the display of the VR device by broadcasting at least one child volumetric video with the parent volumetric video on the display of a first virtual reality (VR) device. These collaboration environments may, in some approaches described above, be independently displayed on the display in that contours may be included on the display to allow the different volumetric videos and/or collaboration environments to remain distinguishable from one another. In contrast, as will now be described below, in some approaches, a parent-child collaboration environment may be created that includes portions of the parent collaboration environment and portions of the child collaboration environment(s). The parent-child collaboration environment allows the parent collaboration environments and child collaboration environments to be combined based on an aggregation of the parent volumetric video and at least one of the child volumetric videos into a cohesive dataset. During this combination, it may be ensured that the relative positions of child volumetric videos within the parent volumetric video are accurately maintained, which may involve precise alignment and synchronization of the volumetric videos using techniques that would become apparent to one of ordinary skill in the art after reading the descriptions herein.

The process of establishing a parent-child collaboration environment may, in some approaches, include performing a contextual analysis of the child volumetric video and the parent volumetric video to determine correlations between the child collaboration environment and the parent collaboration environment, e.g., see operation 218. The contextual analysis of the child volumetric video and the parent volumetric video may, in some approaches, be supplemented with identified user sentiments (such as user interactions in the real world and/or within a collaboration environment), and preferably include identifying portions of the parent volumetric video that one or more portions of the child volumetric video(s) can be integrated into. This allows for personalized and adaptive experiences, and even assignment recommendations within the display that the user may optionally select. In some other approaches, this contextual analysis of the child volumetric video and the parent volumetric video includes identifying portions of the parent volumetric video that the child volumetric videos correlate with, e.g., a first viewing perspective within a first of the child volumetric videos may be determined to have a correlation with a first viewing perspective within the parent volumetric video based on the cameras used to capture the video feed data having at least a predetermined degree of similarity. In some other approaches, the contextual analysis may identify one or more volumetric videos and/or portions thereof that are not ideal candidates for establishing the parent-child collaboration environment, e.g., out of focus video, blocked views of the first event, etc.

Operation 220 includes generating, based on the determined correlations, a parent-child collaboration environment that incorporates first aspects of the child collaboration environment and second aspects of the parent collaboration environment. A technical effect of generating the parent-child collaboration environment includes relative enhancement of the collaboration environment in that blended collaboration environments are enabled (blended based on the incorporation of the first aspects of the child collaboration environment and second aspects of the parent collaboration environment). This relatively expands the technical field of volumetric videos and virtual worlds which has never previously offered this technical effect.

In some preferred approaches, the parent-child collaboration environment may be based on the parent volumetric video and/or the parent collaboration environment being supplemented to include, e.g., an aggregation is performed, one or more aspects of the child volumetric video(s) and/or the parent collaboration environment(s). For context, the aspects may include, e.g., portions of the volumetric videos such as a portion of a feed of a viewing perspective of the first event, portions of the collaboration environments, objects of interest of the volumetric videos, etc., that are incorporated into the parent-child collaboration environment. In some approaches, the aspects that are incorporated into the parent-child collaboration environment may depend on what is currently displayed on at least the majority portion of the display. In other words, in some approaches, as a current viewing perspective of the display changes, the parent volumetric video may be supplemented with different aspects of the child volumetric videos. This way, the current view of the parent-child collaboration environment may, depending on the viewing perspective, include meshed portions of both parent and child volumetric videos and/or environments. For example, assuming that a current viewing perspective on a majority portion of the display includes a viewing perspective from a first end of a sports stadium, child volumetric videos and portions of the parent volumetric videos that have at least a predetermined degree of similarity may be assigned to the portions of the display. This predetermined degree of similarity may, in some approaches, be based on devices that captured the associated video feed data having, e.g., within 5% angular difference of a viewing perspective, within 10% angular difference of a viewing perspective, within 15% angular difference of a viewing perspective, etc. Combining, e.g., meshing, portions of the child volumetric video and/or the child collaboration environment and the parent volumetric video and/or the parent collaboration environment may be achieved using techniques that would become apparent to one of ordinary skill in the art after reading the descriptions herein.

In some approaches, the parent-child collaboration environment may be refined and/or generated based on user parameters of users that are anticipated to view and navigate within the parent-child collaboration environment. Accordingly, method 200 optionally includes obtaining user input that details predetermined parameters to incorporate into a parent-child collaboration environment. These predetermined parameters may include preferences such as sports team preferences, club memberships, collaboration interaction preferences, etc. This information may be obtained from sources such as publicly available profile information, user provided preferences, recording behavior of operators that are expected to navigate the parent-child collaboration environment, etc. The parent-child collaboration environment is optionally generated based on the obtained user input and thereby incorporates the predetermined parameters. In some approaches, one or more aspects of the child collaboration environment and/or one or more aspects of the parent collaboration environment may be excluded from the parent-child collaboration environment based on a determination that such aspects do not fit the predetermined parameters.

A technical effect of incorporating these user inputs includes tailoring user preferences into the collaboration environments. A computing performance benefit that is enabled by tailoring user preferences into collaboration environments includes relatively reducing an amount of processing operations that would otherwise be performed processing user-initiated adjustments (where the adjustment would otherwise be initiated if the collaboration environments did not consider such preferences before being output for display).

A combined volumetric video dataset that results from combining the portions of the child volumetric video and/or the child collaboration environment and the parent volumetric video and/or the parent collaboration environment may be integrated into a collaboration environment by utilizing predetermined collaboration environment development platforms, which may depend on the specifications of the parent-child collaboration environment. In other words, in some approaches, method 200 includes outputting the combined volumetric video dataset to a predetermined collaboration environment development platform with instructions that detail how to deploy the parent-child collaboration environment.

In some approaches, method 200 includes generating hierarchical navigation paths that enable navigation between the different collaboration environments, e.g., see operation 222. These hierarchical navigation paths serve as a mapping between the different collaboration environments and may, in some approaches, include points that a user may navigate to during the user's navigation of one or more of the collaboration environments that are currently displayed on the display of the VR device. For example, a user wearing the VR device may navigate from a first location within the parent collaboration environment, e.g., a first point, to a second location within the parent collaboration environment, e.g., a second point. This navigation may be identified within received user selections, e.g., see operation 224. For example, these user selections may include, e.g., selections made on a touch sensitive portion of the display, tracked eye movements, predetermined navigation actions performed on a remote paired with the VR device, etc. In some approaches, the second location may be a predetermined point that is based on child video feed data obtained from a user device, and the user selections causing the navigation from the first point to the second point may constitute user selections that pursue a predetermined first one of the hierarchical navigation paths. In response to a determination that these user selections pursue the predetermined first hierarchical navigation path, predetermined first assignments that are associated with the predetermined first hierarchical navigation path are caused to be output to the VR device, e.g., see operation 226. In some approaches, the predetermined first assignments that are associated with the predetermined first hierarchical navigation path may include a given child collaboration environment being displayed on at least the majority portion of the display. Accordingly, in one or more of such approaches, at least the majority portion of the display may be caused to switch from displaying the parent collaboration environment to displaying the given child collaboration environment.

The generated hierarchical navigation paths may additionally and/or alternatively include jump options that enable a user to toggle between the different points of a currently displayed collaboration environment. These points may be indicated using spatial anchors and/or markers to denote entry points between different collaboration environments and/or locations therein. For example, in some approaches, these spatial anchors and/or markers include selectable options tabs on the display, such as in the minority portions of the display. Accordingly, in some approaches, based on these points being indicated, a user navigating a first of the collaboration environments may be able to view a second of the collaboration environments. In some approaches, these jump options adjust a current viewing perspective that is displayed on the display of the VR device based on limited volumetric video feed being available between the points. In other words, the child collaboration environment may be based on child video feed data obtained from a user device located at a first viewing perspective of a location where the first event is occurring, but, because a user device is not located at a second viewing perspective at the location, the user is not provided with a hierarchical navigation path jump option to the second viewing perspective (in other words some viewing perspectives may be non-volumetric child collaboration environments such as fan clubs).

The generated hierarchical navigation paths allow users viewing the display to visualize collaboration environments while in a different collaboration environment, and therefore have a technical effect of promoting navigation within the different collaboration environments. Then, based on the user navigation instructions, e.g., selections, visual directions, etc., a story of the reaction of participants within the different collaboration environments may be created. For example, a reporter may use the VR device to watch the reaction of different fan groups and may thereby generate a comprehensive story of the participating viewers in one or more of the collaboration environments.

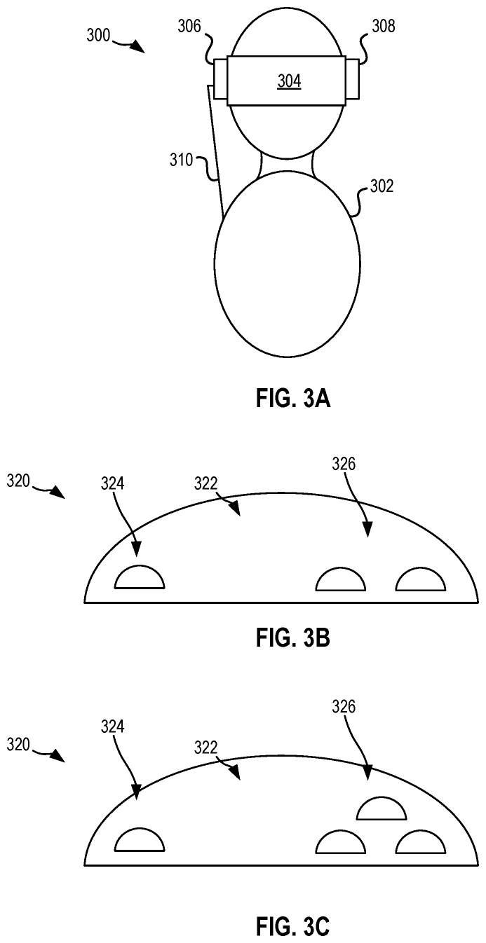

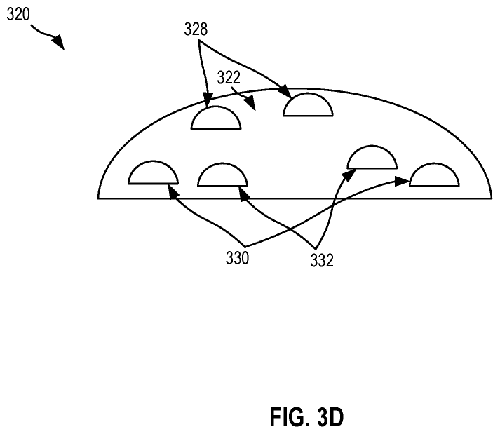

FIG. 3A depicts a VR device 300 worn by a user and FIGS. 3B-3D depict a display 320 of the VR device worn by the user, in accordance with several approaches. As an option, the present VR device 300 and display 320 may be implemented in conjunction with features from any other approach listed herein, such as those described with reference to the other FIGS. Of course, however, such VR device 300 and display 320 and others presented herein may be used in various applications and/or in permutations which may or may not be specifically described in the illustrative approaches listed herein. Further, the VR device 300 and display 320 presented herein may be used in any desired environment.

Referring first to FIG. 3A, the VR device 300 is worn by a user 302. Although the VR device is shown in the current approach to be a headset type VR device, in some other approaches, the VR device may additionally and/or alternatively include a spherical bubble, glasses, contact lenses, etc. The VR device includes a display portion 304, and retention portions 306-308, which may include, e.g., straps, arms, etc. Furthermore, the VR device 300 includes a power cord 310 for powering the display portion 304.

An interior view of a display 320 of the display portion is shown in FIGS. 3B-3D. In FIG. 3B, a child volumetric video may be caused to be broadcast with a parent volumetric video on the display. Specifically, in some approaches, a parent volumetric video may be assigned to be broadcast on a majority portion 322 of the display 320. In contrast, at least some child volumetric videos may be assigned to be broadcast on a first subset of minority portions 326 of the display 320, and another child volumetric video may be caused to be broadcast on a second subset of minority portions 324 of the display 320. Furthermore, in some approaches, these different portions of the display may be caused to be distinguishable by contours around the minority portions. In contrast, in some other approaches, no contours are present in the display, and instead, the different volumetric videos are merged together to establish a navigable collaboration environment. In order to perform this merging, in some approaches, same relative positions of the child volumetric videos may be retained in the parent volumetric video.

The assignments described above may be dynamically changed at any time. For example, referring now to FIG. 3C, an additional child volumetric video is assigned to be broadcast on the first subset of minority portions 326 of the display 320.

Referring now to FIG. 3D, the display 320 includes a majority portion 322 that broadcasts a parent volumetric video, e.g., such as an entire sports stadium, and a plurality of minority portions. A first subset of the minority portions 328 broadcast child volumetric videos that are based on child video feed data obtained from a plurality of user devices. A second subset of the minority portions 330 broadcast child non-volumetric videos that are based on child video feed data obtained from a plurality of user devices, e.g., a fan club. Finally, a third subset of the minority portions 332 broadcast other child volumetric videos.

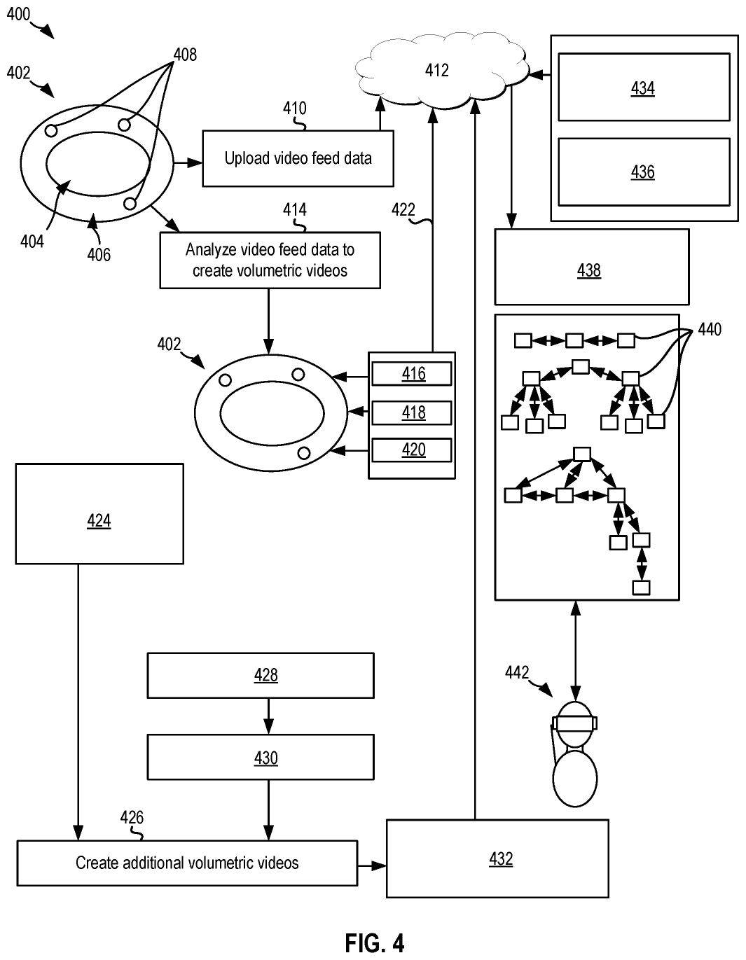

Now referring to FIG. 4, a flowchart of a method 400 is shown according to one approach. The method 400 may be performed in accordance with the present invention in any of the environments depicted in FIGS. 1-4, among others, in various approaches. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various approaches, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

In some approaches, method 400 is based on video data that is captured during a live sports event that occurs at a stadium 402. The stadium includes a field portion 404 where teammates play, and stands 406 where users who are audience members spectate the sports event and record, from different directions, at least portions of the sports event on user devices, e.g., see stand locations 408. These recordings may be child video feed data from a plurality of user devices that, along with parent video feed data, may be uploaded to a cloud server 412, e.g., see operation 410. The cloud server may analyze the video feed data to generate volumetric videos, e.g., a parent volumetric video, child volumetric video(s), etc. In some other approaches, user input of the users that used the user devices to capture the video feed data may be used to group the video feed data to create a plurality of child volumetric videos, e.g., see operation 414. In some approaches, this grouping may establish sub-groups of the child volumetric videos, e.g., a first sub-group of the child volumetric videos that establish a first fan group 416 of a first player, a second sub-group of the child volumetric videos that establish a second fan group 418 of a second player, a third sub-group of the child volumetric videos that establish a third fan group 420 of a third player, etc. These volumetric videos groupings may be uploaded to the cloud server, e.g., see operation 422.

While watching the live event in any metaverse collaborative environment, e.g., such as on an interactive television 424, user devices of the different participating users may optionally create different child volumetric videos that may be broadcast together with other volumetric videos, e.g., see operation 426. Furthermore, permissibly accessed information and shared user interaction on social media sites may be identified, e.g., see operation 428, and used to optionally create additional child volumetric videos, e.g., see operation 430. While creating these child volumetric videos and/or collaboration environments, various types of information outside of the physical surroundings of the live event, e.g., such as photographs, videos etc., which may be obtained from a social network site, may be incorporated into the child volumetric videos and/or collaboration environments. Any of these child volumetric videos and/or collaboration environments based on the child volumetric videos may be published to the cloud server, e.g., see operation 432.

In operation 434, the cloud server 412 analyzes a context of the different generated volumetric videos and/or sentiment of the participants to identify which of the volumetric videos are correlated with one another. Based on the identified correlation(s) (if any) parent child hierarchical relationships among the volumetric videos may be created, e.g., see operation 436. More specifically, based on the context of the correlated volumetric videos, hierarchical navigation paths may be generated that enable navigation between the different collaboration environments, e.g., see operation 438. These hierarchical navigation paths may include points 440, as described elsewhere herein, e.g., see method 200. User selections may be received, and in response to a determination that the user selections pursue a predetermined first one of the hierarchical navigation paths, predetermined first assignments that are associated with the predetermined first hierarchical navigation path to be output to a VR device 442.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method (CIM), the CIM comprising:
obtaining child video feed data from a plurality of user devices that are utilized to record a first event;
generating, using the obtained child video feed data, a child volumetric video; and
causing the child volumetric video to be broadcast with a parent volumetric video of the first event on a display of a first virtual reality (VR) device.

2. The CIM of claim 1, wherein a plurality of child volumetric videos are generated and caused to be broadcast with the parent volumetric video of the first event on the display, and comprising:
obtaining parent video feed data from a plurality of dedicated volumetric video devices that are utilized to record the first event;
generating, using the obtained parent video feed data, the parent volumetric video;
causing the child volumetric videos to be incorporated into at least one child collaboration environment; and
causing the parent volumetric video to be incorporated into a parent collaboration environment.

3. The CIM of claim 2, comprising:
identifying relative locations of the user devices at the first event; and
incorporating the identified relative locations into associated viewing perspectives within the child volumetric videos and the child collaboration environment(s).

4. The CIM of claim 2, comprising:
evaluating the child video feed data to determine recording behavior similarities of operators of a first subset of the user devices during the recording of the first event,
wherein causing the child volumetric videos to be broadcast with the parent volumetric video of the first event on the display includes:
assigning the parent volumetric video to a majority portion of the display,
assigning the child volumetric videos generated using the child video feed data obtained from the first subset of the user devices to first minority portions of the display, and
assigning a remainder of the child volumetric videos to second minority portions of the display,
wherein each of the first minority portions of the display are grouped together on the display,
wherein the first minority portions of the display are not grouped together with the second minority portions on the display.

5. The CIM of claim 4, wherein the first minority portions of the display include first contours to be distinguishable from the majority portion of the display, wherein the second minority portions of the display include second contours to be distinguishable from the majority portion of the display, wherein the recording behavior similarities are selected from a group consisting of: an amount of time spent recording a person of interest exceeding a predetermined threshold within a predetermined amount of time, an amount of time spent recording an object of interest exceeding a predetermined threshold within a predetermined amount of time, and a first sports team being recorded relatively more than a second sports team.

6. The CIM of claim 4, comprising: in response to a determination that a predetermined selection action has been performed, assigning one of the child volumetric videos to the majority portion of the display and assigning the parent volumetric video to one of the minority portions of the display.

7. The CIM of claim 1, comprising:
causing the child volumetric video to be incorporated into a child collaboration environment;
causing the parent volumetric video to be incorporated into a parent collaboration environment that is a different collaboration environment than the child collaboration environment;
performing a contextual analysis of the child volumetric video and the parent volumetric video to determine correlations between the child collaboration environment and the parent collaboration environment; and
generating, based on the determined correlations, a parent-child collaboration environment that incorporates first aspects of the child collaboration environment and second aspects of the parent collaboration environment.

8. The CIM of claim 7, comprising:
generating hierarchical navigation paths that enable navigation between the different collaboration environments;
receiving user selections; and
in response to a determination that the user selections pursue a predetermined first one of the hierarchical navigation paths, causing predetermined first assignments that are associated with the predetermined first hierarchical navigation path to be output to the VR device.

9. The CIM of claim 7, comprising:
obtaining user input that details predetermined parameters to incorporate into a parent-child collaboration environment,
wherein the predetermined parameters are selected from the group consisting of: sports team preferences, club memberships, and collaboration interaction preferences,
wherein the parent-child collaboration environment is generated based on the obtained user input and thereby incorporates the predetermined parameters.

10. A computer program product (CPP), the CPP comprising:
a set of one or more computer-readable storage media;
program instructions, collectively stored in the set of one or more storage media, for causing a processor set to perform the following computer operations:
obtain child video feed data from a plurality of user devices that are utilized to record a first event;
generate, using the obtained child video feed data, a child volumetric video; and
cause the child volumetric video to be broadcast with a parent volumetric video of the first event on a display of a first virtual reality (VR) device.

11. The CPP of claim 10, wherein a plurality of child volumetric videos are generated and caused to be broadcast with the parent volumetric video of the first event on the display, and the CPP comprising: program instructions for causing the processor set to perform the following computer operations:
obtain parent video feed data from a plurality of dedicated volumetric video devices that are utilized to record the first event;
generate, using the obtained parent video feed data, the parent volumetric video;
cause the child volumetric videos to be incorporated into at least one child collaboration environment; and
cause the parent volumetric video to be incorporated into a parent collaboration environment.

12. The CPP of claim 11, the CPP comprising: program instructions for causing the processor set to perform the following computer operations:
identify relative locations of the user devices at the first event; and
incorporate the identified relative locations into associated viewing perspectives within the child volumetric videos and the child collaboration environment(s).

13. The CPP of claim 11, the CPP comprising: program instructions for causing the processor set to perform the following computer operations:
evaluate the child video feed data to determine recording behavior similarities of operators of a first subset of the user devices during the recording of the first event,
wherein causing the child volumetric videos to be broadcast with the parent volumetric video of the first event on the display includes:
assigning the parent volumetric video to a majority portion of the display,
assigning the child volumetric videos generated using the child video feed data obtained from the first subset of the user devices to first minority portions of the display, and
assigning a remainder of the child volumetric videos to second minority portions of the display,
wherein each of the first minority portions of the display are grouped together on the display,
wherein the first minority portions of the display are not grouped together with the second minority portions on the display.

14. The CPP of claim 13, wherein the first minority portions of the display include first contours to be distinguishable from the majority portion of the display, wherein the second minority portions of the display include second contours to be distinguishable from the majority portion of the display, wherein the recording behavior similarities are selected from a group consisting of: an amount of time spent recording a person of interest exceeding a predetermined threshold within a predetermined amount of time, an amount of time spent recording an object of interest exceeding a predetermined threshold within a predetermined amount of time, and a first sports team being recorded relatively more than a second sports team.

15. The CPP of claim 13, the CPP comprising: program instructions for causing the processor set to perform the following computer operations: in response to a determination that a predetermined selection action has been performed, assign one of the child volumetric videos to the majority portion of the display and assign the parent volumetric video to one of the minority portions of the display.

16. The CPP of claim 10, the CPP comprising: program instructions for causing the processor set to perform the following computer operations:
cause the child volumetric video to be incorporated into a child collaboration environment;
cause the parent volumetric video to be incorporated into a parent collaboration environment that is a different collaboration environment than the child collaboration environment;
perform a contextual analysis of the child volumetric video and the parent volumetric video to determine correlations between the child collaboration environment and the parent collaboration environment; and
generate, based on the determined correlations, a parent-child collaboration environment that incorporates first aspects of the child collaboration environment and second aspects of the parent collaboration environment.

17. The CPP of claim 16, the CPP comprising: program instructions for causing the processor set to perform the following computer operations:
generate hierarchical navigation paths that enable navigation between the different collaboration environments;
receive user selections; and
in response to a determination that the user selections pursue a predetermined first one of the hierarchical navigation paths, cause predetermined first assignments that are associated with the predetermined first hierarchical navigation path to be output to the VR device.

18. The CPP of claim 16, the CPP comprising: program instructions for causing the processor set to perform the following computer operations:
obtain user input that details predetermined parameters to incorporate into a parent-child collaboration environment,
wherein the predetermined parameters are selected from the group consisting of: sports team preferences, club memberships, and collaboration interaction preferences,
wherein the parent-child collaboration environment is generated based on the obtained user input and thereby incorporates the predetermined parameters.

19. A computer system (CS), the CS comprising:
a processor set;
a set of one or more computer-readable storage media;
program instructions, collectively stored in the set of one or more storage media, for causing the processor set to perform the following computer operations:
obtain child video feed data from a plurality of user devices that are utilized to record a first event;
generate, using the obtained child video feed data, a child volumetric video; and
cause the child volumetric video to be broadcast with a parent volumetric video of the first event on a display of a first virtual reality (VR) device.

20. The CS of claim 19, wherein a plurality of child volumetric videos are generated and caused to be broadcast with the parent volumetric video of the first event on the display, and the CS comprising: program instructions, collectively stored in the set of one or more storage media, for causing the processor set to perform the following computer operations:
obtain parent video feed data from a plurality of dedicated volumetric video devices that are utilized to record the first event;
generate, using the obtained parent video feed data, the parent volumetric video;
cause the child volumetric videos to be incorporated into at least one child collaboration environment; and
cause the parent volumetric video to be incorporated into a parent collaboration environment.
